(19) United States
(12) Patent Application Publication
(10) Pub. No.: US 2005/0243549 A1
(43) Pub. Date: Nov. 3, 2005

(54) Remote position control of lighting unit

(76) Inventor: Joseph Henry Ruston, London (GB)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/507,393

(22) PCT Filed: Mar. 10, 2003
(86) PCT No.: PCT/GB03/01013

§ 371 Date: Jul. 11, 2005

(30) Foreign Application Priority Data
Mar. 13, 2002 (GB) 0205891.5

(51) Int. Cl. F21S 2/00

(52) U.S. Cl. 362/233; 362/418

(57) ABSTRACT

A lighting unit includes one or more lamps, a motor configured to adjust the position of the lamps, a controller configured to transmit drive signals to the motor in dependence on received signals and, for each of the lamps, a corresponding light detector connected to the controller such that receipt of modulated light at one of the light detectors gives an indication to the controller that the position of the corresponding lamp is to be adjusted. Used with the lighting unit is a remote-control unit, by way of which the user can, firstly, emit the modulated light, preferably laser light, to select the lamp to be moved and, secondly, emit a coded infrared or radio signal to then effect the desired movement of the lamp.

The present invention relates to a lighting unit, and a lighting system comprising a number of said lighting units.

It is well known to have lighting systems comprising a number of lighting units which allow the orientation of individual lamps to be adjusted, so that a required lighting effect can be obtained. Conventionally, the orientation of such lighting units has been adjustable manually, but this can be physically demanding and time consuming. Technology exists to allow this adjustment to be automated and controlled remotely. However, there are problems in producing such an automated system that has a simple and flexible means for selecting individual lamps for adjustment.

According to a first aspect of the present invention there is provided a lighting unit comprising: a number of individually moveable lamps; motor means configured to adjust the position of said lamps; controlling means configured to transmit drive signals to said motor means in dependence upon received control signals; and for each one of said lamps, a corresponding light detector, connected to said controlling means such that receipt of modulated light at one of said light detectors provides an indication to said controlling means that the position of the corresponding lamp is to be adjusted.

The invention will now be described by way of example only, with reference to the accompanying drawings, in which;

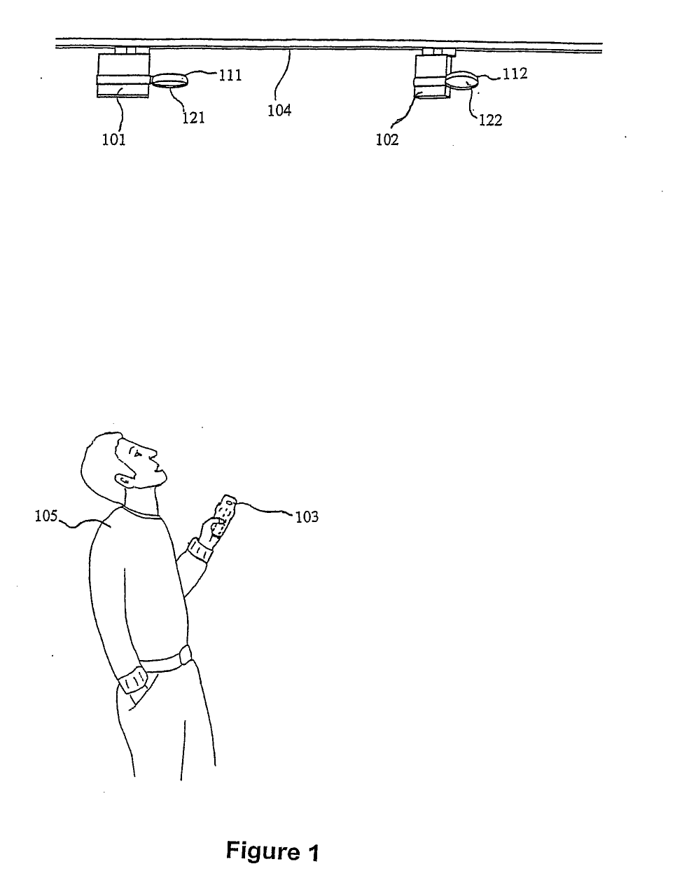

FIG. 1 shows a lighting system comprises two lighting units and a portable remote control unit;

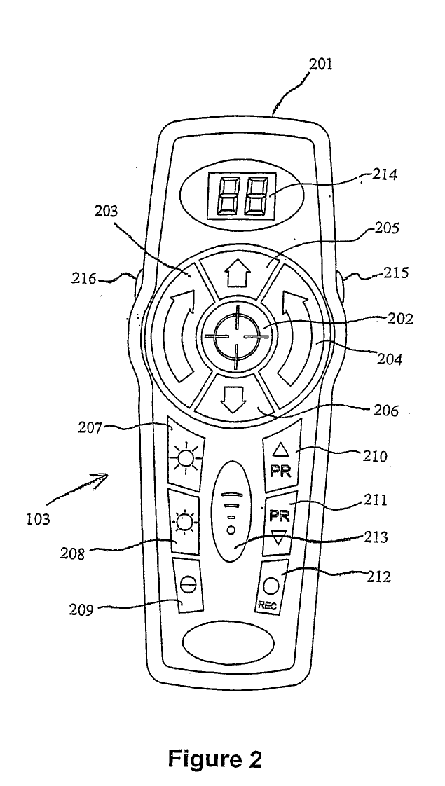

FIG. 2 shows the remote control unit of FIG. 1 in more detail;

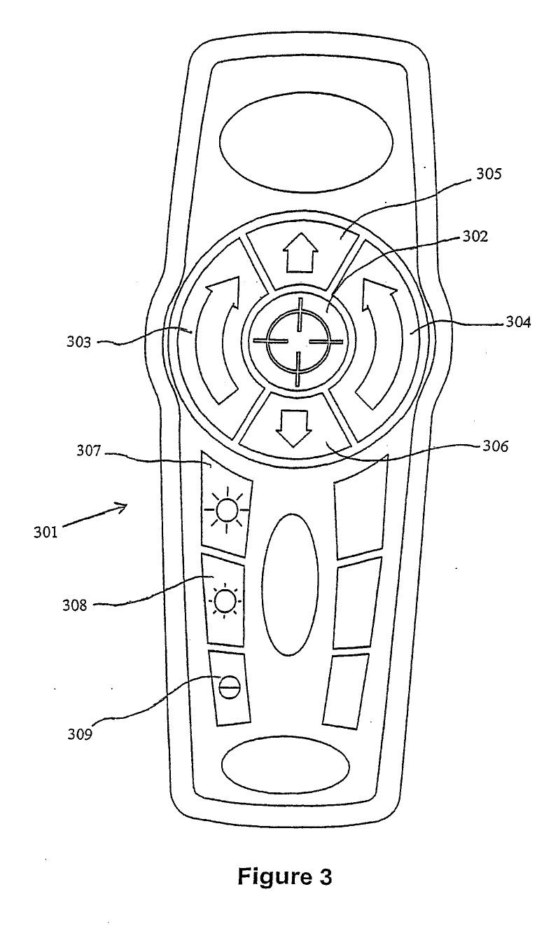

FIG. 3 shows an alternative remote control unit to that of FIG. 2;

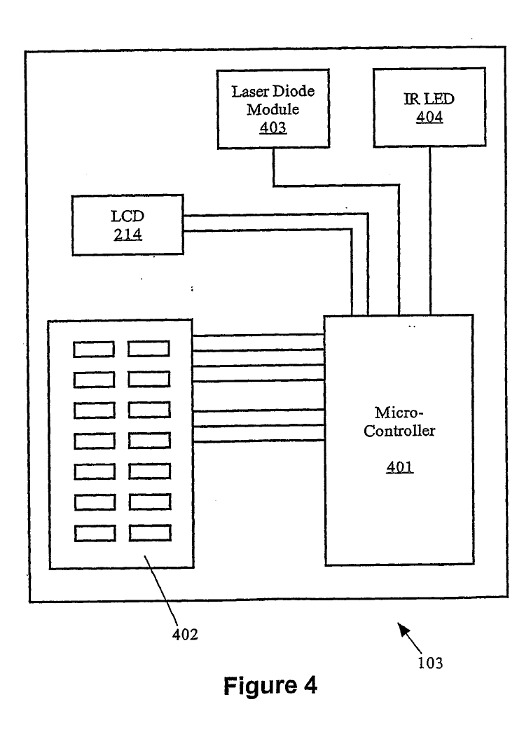

FIG. 4 shows schematically the main components of the remote control unit of FIG. 2;

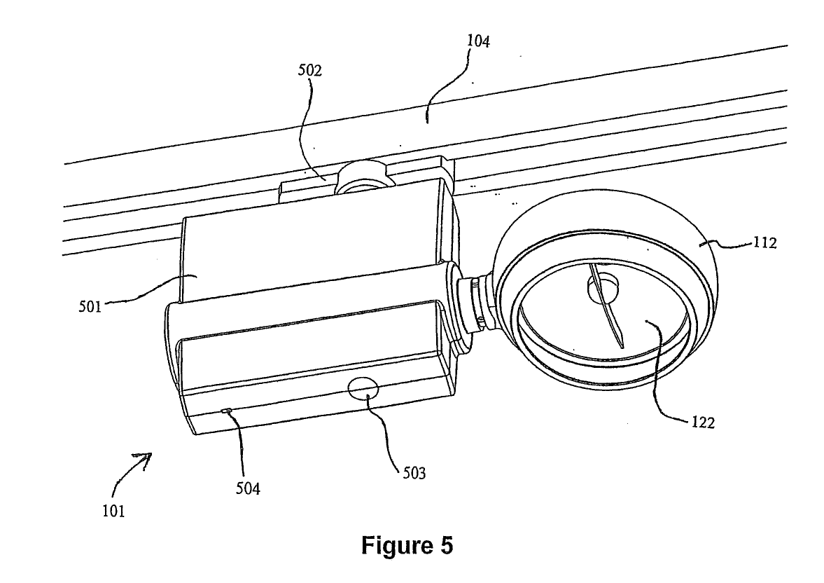

FIG. 5 shows an isometric view of the lighting unit 101 of FIG. 1;

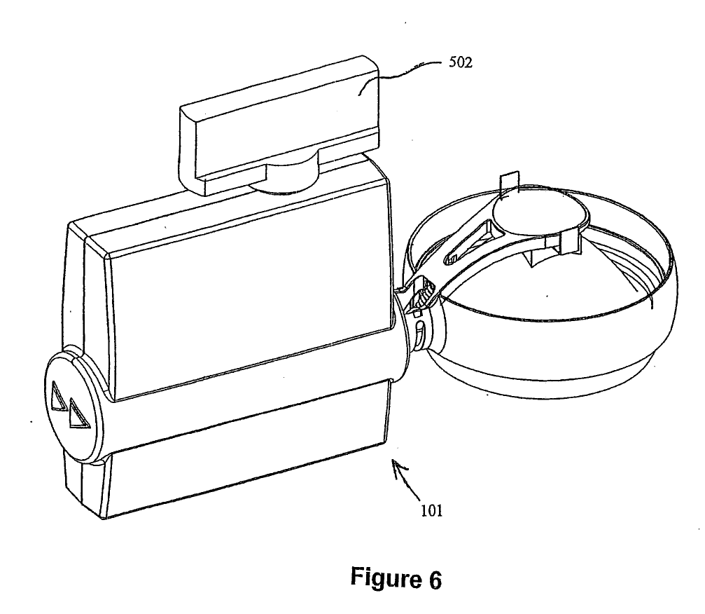

FIG. 6 shows the lighting unit 101 of FIG. 1, removed from the lighting track;

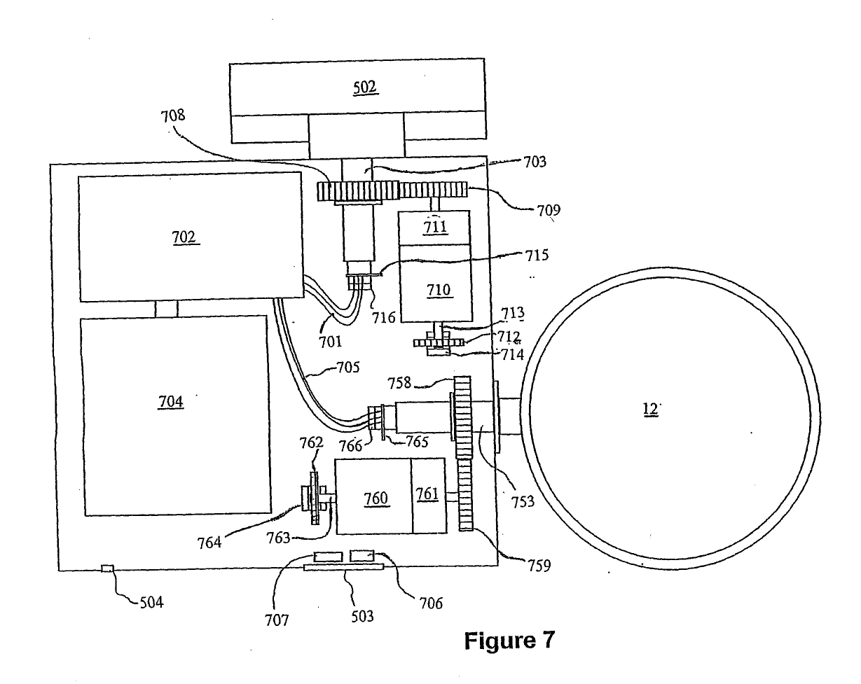

FIG. 7 shows the general physical layout of components within the body of lighting unit 101;

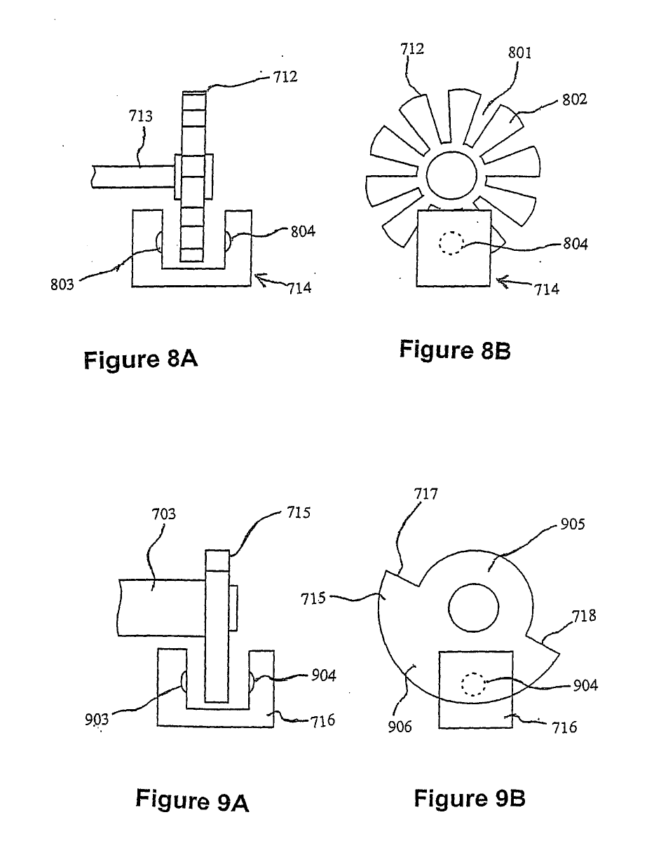

FIGS. 8A and 8B show the tacho disc 712 and optical sensor 714 in a side view and an end view respectively;

FIGS. 9A and 9B show the home flag 715 and corresponding sensor 716 in a side view and an end view respectively;

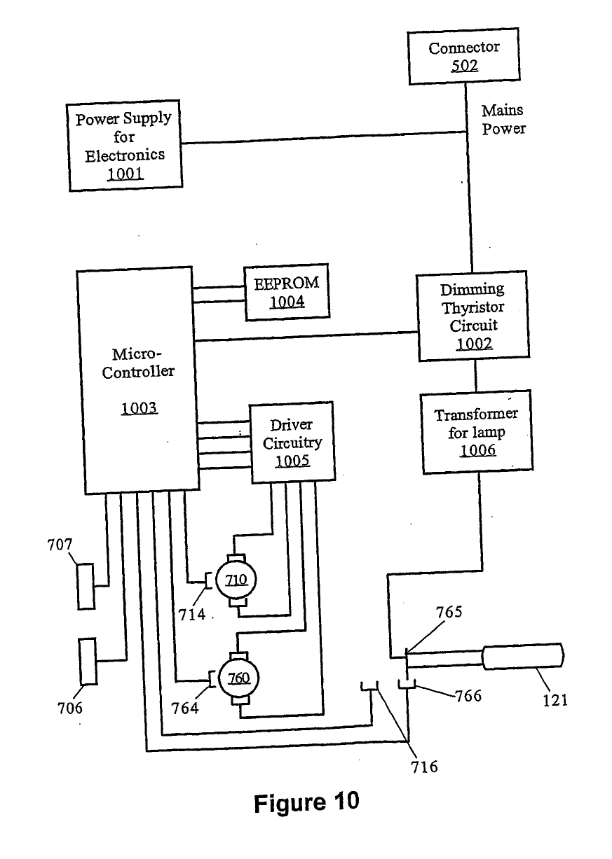

FIG. 10 shows the main electrical and electronic elements of the lighting unit 101;

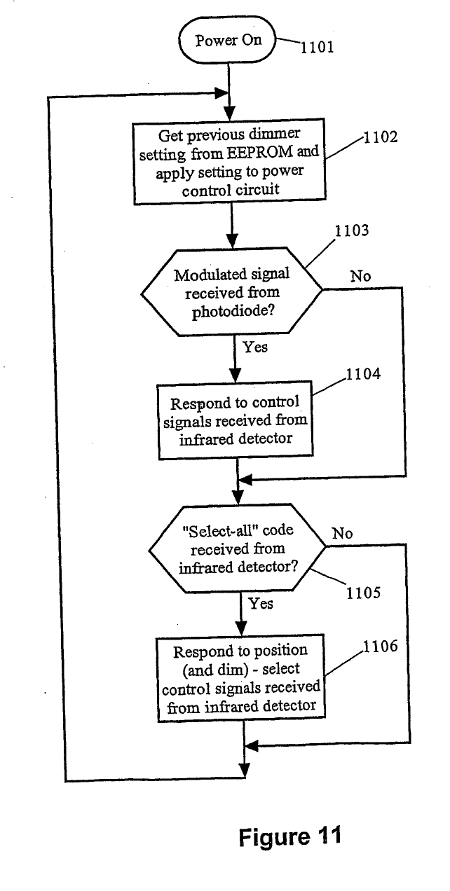

FIG. 11 shows a flow-chart outlining the operation of the micro-controller of the lighting unit 101;

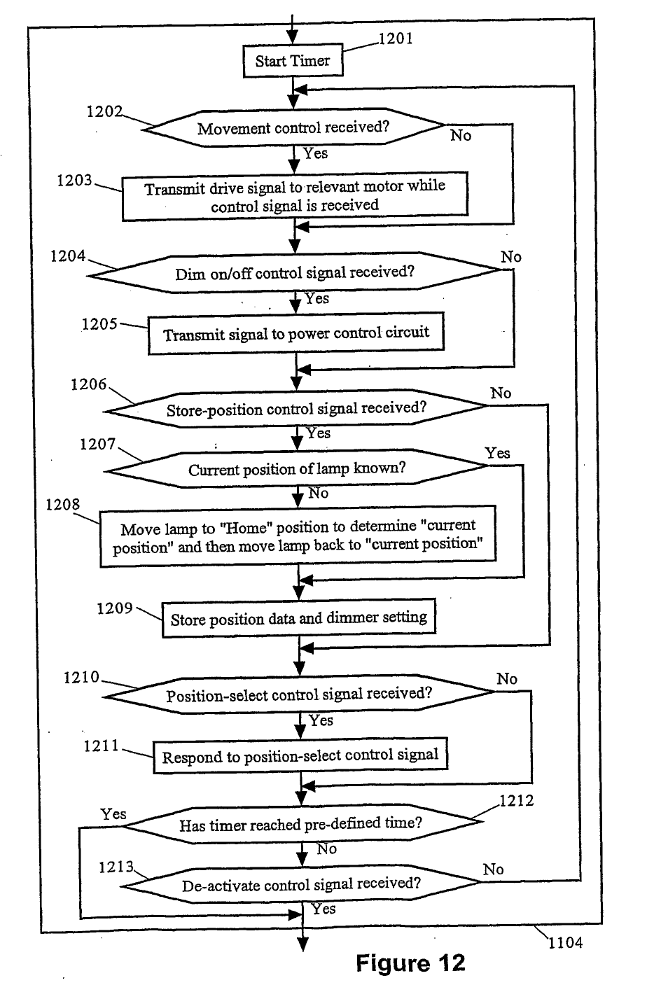

FIG. 12 shows, in further detail, the step 1104 of responding to control signals received from the infrared detector;

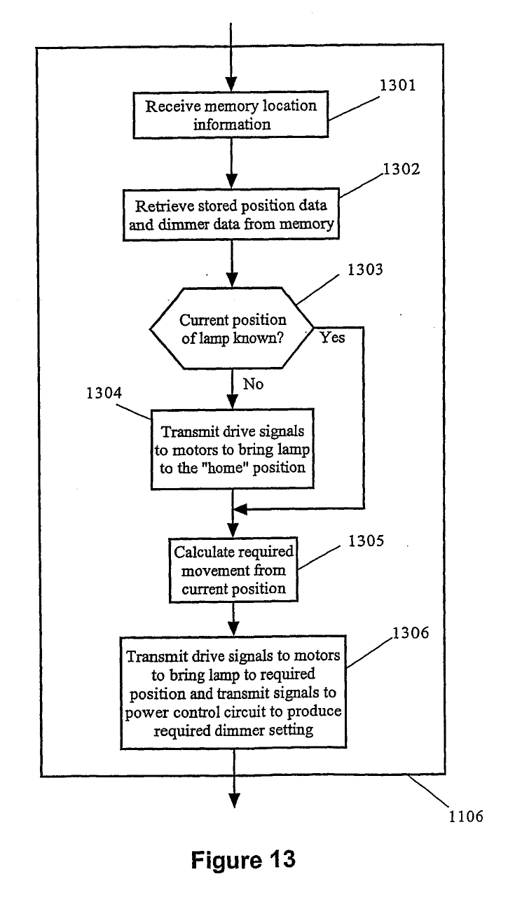

FIG. 13 shows, in further detail, the step 1106 of responding to “position-select” control signals;

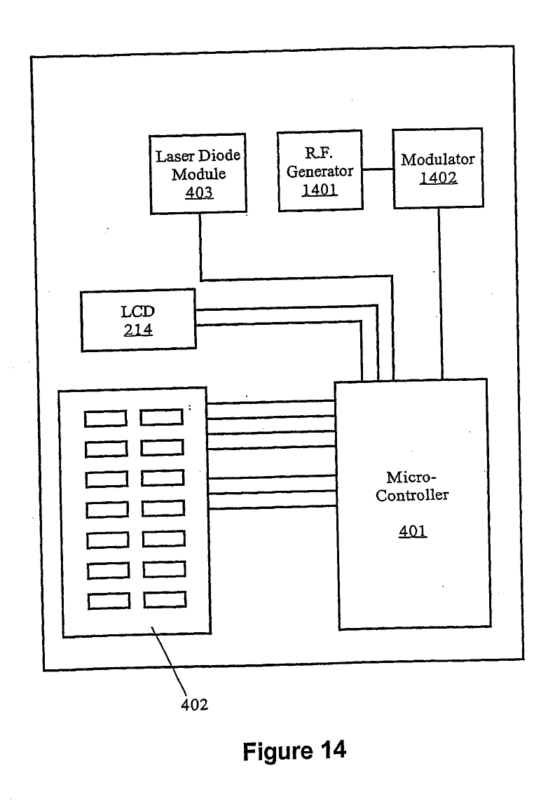

FIG. 14 shows schematically the main components of an alternative remote control unit to that of FIG. 4; and

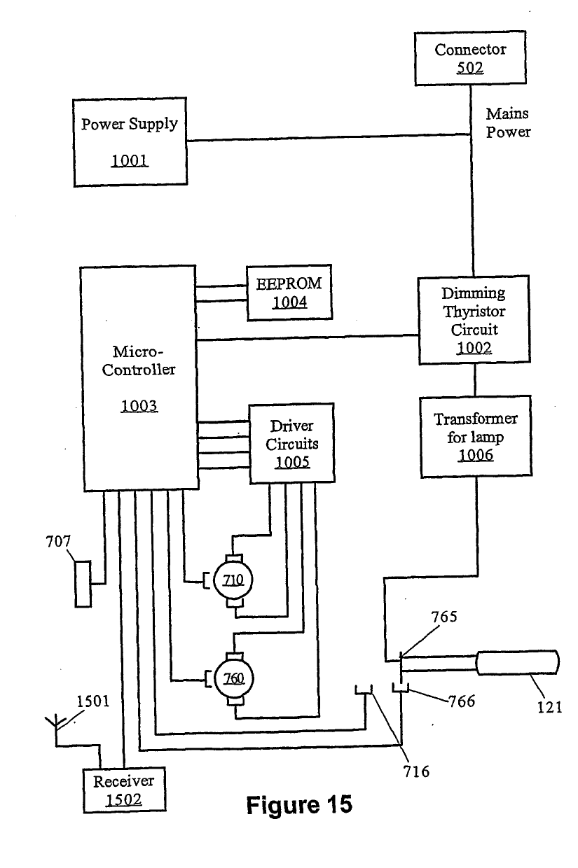

FIG. 15 shows schematically the main electrical and electronic elements of an alternative lighting unit, suitable for receiving commands from the remote control unit of FIG. 14.

### FIG. 1

A lighting system is shown in FIG. 1. The lighting system comprises two lighting units 101 and 102 and a portable remote control unit 103. The lighting units 101 and 102 are alike, and each have a lamp housing, 111 and 112 respectively, which house lamps 121 and 122 respectively. The lamps in this example are halogen PAR36 lamps. However, other electric lamps which are capable of producing a beam of light may be used.

The lighting units 101 and 102 are attached to a conventional lighting track 104 from which they receive mains electricity. The lighting track 104 is itself mounted to the ceiling of the room that is occupied by the system's human operator 105. The lighting system is suitable for illuminating any area where directed light is desired. For example the system is suitable for dining areas, art galleries etc. As will be understood from the following description, the operator 105 requires little technical understanding in order to adjust the lighting within the room.

The light units 101 and 102 each contain electric motors by which they are capable of individually panning and tiling their respective lamps. In addition, the units contain power control circuitry allowing the power supplied to their lamps to be individually varied, i.e. the lamps may be dimmed, or switched off. The panning, tilting and dimming of each lamp is controlled by the operator 105 using the remote control unit 103.

In order to effect communication between the remote control unit 103, and the lighting units 101 and 102, the remote control unit emits two distinct types of radiation, and the lighting units have sensors which are arranged to detect these types of radiation. The first radiation type is modulated light, and in the present example this takes the form of modulated laser light. The second radiation type in the present embodiment is modulated and coded infrared.

The two types of radiation have two distinct uses. The narrow beam of light is used by the operator to select a particular lamp which is to be adjusted. On selection of a lamp, the relevant lighting unit enters an activated mode in which it will receive and respond to commands received via the coded infrared. The infrared is therefore used to transmit command codes to a selected lighting unit regarding a lamp's movement, position, dimming etc.

For example, in order to adjust the orientation of a chosen lamp, in this case either the lamp 121 or 122, firstly the lamp has to be selected, thus putting the relevant lighting unit into the activated mode. To do this, the operator presses a button on the remote control unit 103, which results in the remote control unit generating a narrow beam of modulated light. In this example, the remote control unit 103 contains a laser diode which it uses to generate the light beam. This modulated light beam is directed by the operator 105 onto a light detecting sensor located on the under side of the chosen lighting unit. On receiving the modulated light at the sensor, the lighting unit illuminates a green light emitting diode (LED) to indicate to the operator that the lamp has been selected, and the lighting unit enters its activated mode.

Thus, the beam of light used to select a lamp has to be sufficiently narrow so that it may be shone onto a particular sensor without illuminating other light sensors corresponding to neighbouring lamps.

On observing the illuminated green LED, the operator then selects and presses a second button on the remote control. By pressing the relevant button, the operator may command the lighting unit to pan the selected lamp clockwise or anticlockwise, tilt the lamp up or down, dim the lamp up or down, or switch the lamp off or on. While adjusting the position of the lamp, the task is usually made easier if the operator can observe the beam produced by the lamp rather than the lamp itself. For example if the lighting unit is used in an art gallery, the operator may watch the beam of light as it is moved towards a sculpture. For this reason, the infrared transmitted by the remote control unit 103 is a broad beam, allowing the operator to make adjustments without having to be too accurate when pointing the remote control towards the lighting unit.

It should be noted that the two lighting units are manufactured to be indistinguishable, and are arranged to receive and respond to the same modulated light as each other, the same infrared as each other, and the same codes carried by the infrared as each other. Nevertheless, because each lamp is selectable by the modulated laser light, the movement and brightness of each lamp is individually controllable.

Furthermore, it may now be understood, that ff there was requirement for additional lighting units, then units similar to units 101 and 102 may be connected to the lighting track, or another lighting track within the room, and operated on an individual basis using the same remote control. This is done without the need for rewiring or reprogramming of the lighting units or the remote control unit 201, because all lighting units, such as 101, of a system respond to the same type of modulated light and the same infrared codes. I.e. the lighting units do not have to be programmed with an identity code which identifies them before being installed within a system. Therefore, the lighting system may be expanded to include an unlimited number of such lighting units.

In addition to controlling lamp movement etc., by pressing another button on the remote control unit 103, the operator is also able to store information defining the current orientation of the lamp, or move the lamp to a position defined by stored information. For example, the operator 105 may frequently require the lamp 121 to be repositioned to one or more particular orientations, and thus, having positioned a lamp in an orientation which is considered useful, the operator may command the lighting unit to store information defining this orientation. Then, in the future, when that same orientation is required again, the operator may command the lighting unit to recall the stored information and thus cause the lighting unit to move the lamp to said orientation.

### FIG. 2

The remote control unit 103 of FIG. 1 is shown in detail in FIG. 2. The remote control unit 103 is of a size and weight which allows it to be easily carried by hand. The laser diode (not shown in FIG. 2) and the infrared LED (not shown in FIG. 2) are mounted at a front end 201 of the remote control unit, so that when energised, their respective beams extend forward from said front end. The remote control unit 103 has a single button 202 which is depressed to energise the laser diode, and is held down while the operator directs the laser beam onto the sensor of a chosen lamp. Located adjacent to button 202 there is a button 203 for panning clockwise, a button 204 for panning anticlockwise, a button 205 for tilting up, and a button 206 for tilting down. In addition, there are buttons for dimming up, 207, dimming down, 208, and switching the lamp on and off, 209.

Therefore, if the orientation of any chosen lamp is to be adjusted, the operator simply presses the laser button 202 and directs the laser beam at the sensor corresponding to the chosen lamp, then having observed from the lighting unit's LED that it has been selected, the operator presses the relevant one of the four positioning buttons 202 to 205.

The remaining four buttons 210, 211, 212 and 213, on the upper surface of the remote control unit 103, are concerned with the storing and recalling of useful lamp orientations and dimmer settings. The remote control unit also has a liquid crystal display (LCD) 214 which facilitates the use of these four buttons. The lighting units 101 and 102 are each capable of storing information defining twenty-three different lamp orientations/dimming control settings. Therefore, when a lamp has been manoeuvred to a useful position, which is to be stored, the operator must first select a number between one and twenty-three that will identify that position. This number selection is carried out by depressing a pre-set up button 210 or a pre-set down button 211, as appropriate. Depression of these buttons causes the number displayed by the LCD 214 to increase and decrease, respectively, within the range one to twenty-three. When the desired number is selected and displayed by the LCD 214, the operator then presses the record pre-set button 212. This action has the effect of putting the controller in a record mode. The operator then presses a send-pre-set button 213 which causes the remote control unit 201 to transmit coded infrared to the currently activated lighting unit, commanding the unit to store information defining its present orientation and dimmer control setting within its memory location that is identified by the selected number.

Having stored positional data in this way, the operator may then reposition a chosen lamp by firstly selecting the lamp by means of the laser, selecting the stored position by selecting the relevant number using the buttons 210 and 211 and LCD 214, and then pressing the send-pre-set button 213. On pressing button 213, the remote control unit 201 transmits coded infrared which commands the lighting unit to recall positional data, and dimmer control data, from its relevant memory location, and then to move the selected lamp to the defined position and adjust the dimmer setting as required.

The lighting units 101 and 102 are configured to receive infrared code even when they have not been selected by modulated light, but until a lamp of a lighting unit has been selected, the lighting unit will not respond to received commands. As well as being selected by receiving the modulated light, a lamp is selected when the infrared sensor of a light unit receives a “select-all” code. Because the infrared is transmitted as a relatively wide angled beam, this means that several, or all, lighting units may be selected at once. The lighting units are configured such that if they are selected in this way, they will respond to commands to recall positional data from their memory, and move their lamp to the relevant pre-defined position.

For this purpose, a pair of “select-all” buttons 215 and 216 are located on opposing sides of the remote control unit 103. When the “select-all” buttons 215 and 216 are pressed simultaneously, the remote control unit 103 transmits a “select-all” code by means of its infrared LED.

Therefore, for a particular lighting arrangement, the operator 105 may store positional data for each lighting unit on an individual basis within, for example, memory location number 10. Then, when the same lighting arrangement is required again, the operator may select all of the lighting units by pressing “select-all” buttons 215 and 216, then select the number 10 on LCD 214 before pressing the send-pre-set button 213. Thus, all lighting units can be made to return to pre-set positions simultaneously.

In an alternative lighting system, the lighting units are configured to store ten sets of positional data and dimmer setting control data in memory locations identified as one to ten. However, other memory locations are used to store time intervals relating to movement sequences. For example, a memory location identified as “11” may store a time interval of 10 seconds while a memory location “12” may store a time interval of twenty seconds, etc. If such a lighting unit then receives a command from a remote control unit to recall pre-set data “11”, it interprets such a command as a command to step through a number of stored positions. The lighting unit retrieves the time period of ten seconds from memory location “11”, it then retrieves data from memory locations one to ten and moves the lamp through the corresponding positions, with a ten second delay between each movement. Similarly, if a recall pre-set data “12” command is received, the lamp is again stepped through positions defined by data in memory locations one to ten, but this time with a twenty second delay between lamp movements. By providing the lighting units with this ability to move their lamps through pre-defined positions, the system is able to produce a dynamic lighting display.

### FIG. 3

An alternative remote control unit 301 to that of FIG. 2 is shown in FIG. 3. The appearance of remote control unit 301 is similar to unit 103, except that it does not have a LCD, or the four buttons used for storing and recalling positional data, or the “select-all” buttons. Therefore, it only has a laser activation button 302, four movement control buttons 303, 304, 305, and 306, dim-up button 307, dim-down button 308 and on/off button 309, which have similar functions to the corresponding buttons 202 to 209 of unit 103.

The remote control unit 301 may also be used with the lighting system of FIG. 1, ie with lighting units such as 101 and 102, in instances where a less sophisticated controller is required. For example, the operator 105 may be responsible for setting up pre-set positions and so uses remote control unit 103, while other operators, who may be less skilled, use the simpler control unit 301 to make adjustments to individual light units.

### FIG. 4

The main components of the remote control unit 103 of FIG. 2 are shown schematically in FIG. 4. The remote control unit 103 comprises an eight bit RISC-like micro-controller 401, which has in built program memory PROM (programmable read only memory) containing the unit's operating instructions, and one hundred and sixty bytes of in built RAM (random access memory). A suitable micro-controller is sold by Holtek as part number HT48R50A-1. The micro-controller 401 receives inputs from button switch array 402 comprising the fourteen buttons 202 to 213, 215 and 216. In dependence of received inputs from the button array the micro-controller provides suitable output signals to the LCD 214, the laser diode module 403 or the infrared LED 404.

The laser diode module 403 in the present example is an LM-01 laser module sold by Eubon Technology Co. Ltd. and during operation it receives a signal from the micro-controller 401 causing it to switch on and off at a frequency of one kHz (kilo-Hertz). I.e. it transmits laser light modulated at a frequency of one kHz.

The infrared LED 404 is a sold by Vishay as IR LED type TSUS540. The micro-controller 401 generates control signals by coding a thirty-eight kHz modulated signal, and these control signals are converted to, and transmitted as, an infrared beam by the infrared LED.

### FIG. 5

The lighting unit 101 of FIG. 1, is shown in greater detail in the isometric view of FIG. 5. The lighting unit comprises a body 501 connected by a drive shaft to the lamp housing, and by a second drive shaft to a lighting track connector 502. The lighting unit 101 is connected to the lighting track 104 by means of the lighting track connector 502. In this example the lighting track is manufactured by Eutrac.

As well as receiving mains electricity from the lighting track 104, the connector 502 also supports the weight of the lighting unit 101. Furthermore, the connector 502, when fixed into the lighting track, provides an anchor about which the body 501 and lamp housing 112 can rotate, and thus, panning of the lamp 112 is performed. Tilting of the lamp 112 is simply performed by the lamp housing rotating with respect to the body 501.

The lighting unit 101 is shown in FIG. 5 in, what is referred to as, its ‘home’ position, with its body parallel to the track 104 and its lamp housing directing the lamp downwards. As will be described, the lamp is arranged to be able to orientate itself to the ‘home’ position, and stored positional data is determined with respect to this position.

A flat window 503 is located in the underside of the body 501. The window 503 is transparent to visible light and infrared light at the wavelengths transmitted by the laser diode and infrared LED of the remote control unit 103. Thus, the window 503 allows access of the laser light and infrared to sensors located behind the window.

The green LED 504 which is illuminated when the lamp 112 is selected is also located on the underside of the body 501.

In an alternative embodiment the window 503 is shaped to define a pair of lenses arranged side by side, and configured to focus incoming radiation onto the two sensors.

### FIG. 6

The lighting unit 101 of FIG. 1 is shown removed from the lighting track in FIG. 6. The light unit 101 is a self contained module which can be easily connected and disconnected from a lighting track by means of its connector 502. Therefore, as described earlier, the number of such units included within a track light system may be simply adjusted. In addition, if for any reason a lighting unit requires replacement, this may be done very simply and quickly by uncipping one unit from the track and clipping in a new unit. Furthermore, because the connector 502 is of a conventional type, the lighting unit 101 may be used to replace an existng static type lighting unit within an existing lighting system, without further alteration to that system.

### FIG. 7

The general physical layout of components within the body of lighting unit 101 is shown in FIG. 7. Electric cables 701 connect the terminals of the connector 502 with power supply circuitry 702 within the body 501. The cables 701 enter the body 501 through a hollow drive shaft 703 which connects the connector 502 to the body. The power supply circuitry 702 supplies a regulated voltage to control circuitry 704, and it also contains a transformer which supplies power to the lamp 121 by means of cables which pass through a second hollow drive shaft 753.

For the purposes of simplicity and clarity, other electrical connections have been omitted from FIG. 7 but further detail of this is provided later with respect to FIG. 9.

As described previously, the green indicating LED 504 is located in the lower wall of the body 501, and the infrared sensor 706 and the light sensor 707 are located behind window 503.

The drive shaft 703 is located within bearings so that it may be rotated with respect to the body 501, while it is rigidly attached to connector 502. Thus, in operation the body is rotated by driving the shaft 703. Shaft 703 supports a spur gear 708 which meshes with a drive gear 709 such that, on rotation of the drive gear, the shaft 703 is driven. The drive gear 709 is itself driven by an electric motor 710 via reduction gear 711. The electric motor 710 and reduction gear 711 is a single unit which is configured to rotate the drive gear 709 at approximately eight revolutions per minute when the motor receives twelve volts. In addition to providing the required torque, the gear 711 also ensures that the lamp does not pan when power has been removed from the motor 710.

A slotted tacho disc 712 is rigidly fixed to a back shaft 713 which extends from the rear of the electric motor 710. The tacho disc 712 is located within an optical sensor 714 connected to the control circuitry 704. The optical sensor 714 supplies panning movement information to the control circuitry when the motor operates.

A single slotted disc 715, referred to as the home flag, is rigidly attached to the end of the drive shaft 703. A second optical sensor 716 is positioned so that the home flag rotates through it, as shaft 703 rotates. By means of the optical sensor 716 and the home flag 715, limited rotational positional information is supplied to the control circuitry, such that the control circuitry is able to rotate to shaft 703 to the home position.

The drive shaft 753 which is used to tilt the lamp 122, is similar to drive shaft 703, and therefore has similar, and corresponding, home flag 765, with optical sensor 766, spur gear 758, driven by drive gear 759, itself driven by electric motor 760 via reduction gear 761, electric motor back shaft 763 supporting tacho disc 762 having an associated optical sensor 764. In a similar manner to gear 711, reduction gear 761 provides the required torque to tilt the lamp under the power of the motors, while preventing further tilting when the motors are not being driven.

### FIGS. 8A and 8B

The tacho disc 712 and optical sensor 714 are shown in detail in the side view and end view of FIGS. 8A and 8B respectively. The tacho disc 712, attached to back shaft 713, is a circular disc containing ten slots 801 extending radially inward from its outer edge and thus defining ten radial spokes 802. The sensor 714 comprises an LED 803 and a photodiode 804 which are positioned so as to face opposing sides of the disc 712. As the disc rotates and spokes 802 pass in between the LED 803 and photodiode 804, the photodiode generates a corresponding signal which is supplied to the control circuitry 704. Thus control circuitry 704 receives a signal which provides information of the rotation of the motor 710.

### FIGS. 9A and 9B

The home flag 715 and corresponding sensor 716 are shown in detail in the side view and end view of FIGS. 9A and 9B respectively. The sensor 716 is of the same type as sensor 714, having an LED 903 and a photodiode 904, which face opposite sides of the home flag 715.

The home flag 715, which is fixed to the end of shaft 703, takes the form of a disc from which the outer portion has been removed from one half. Therefore, the disc has a small radius for one half 905 and a larger radius for its other half 906. The difference in the radii of the two halves is such that as the flag 715 rotates, the larger half 906 of the flag comes between the LED 903 and photodiode 904 for half of a revolution while nothing comes between is them for the other half of the revolution. Consequently, as the shaft rotates the photodiode supplies a voltage to the control circuit which depends upon the position of the shaft. Furthermore, two edges 717 and 718 define positions where the radius of the disc changes from the smaller to the larger radius, and by monitoring the voltage from the photodiode 904 these edges are detected. The home position of the shaft 703, and hence the home position for the lighting unit is therefore chosen in respect to one of these edges.

### FIG. 10

The main electrical and electronic elements of the lighting unit 101 are shown schematically in FIG. 10. Mains electricity, received by the track connector 502, is supplied to a power supply 1001 and thyristor circuit 1002. The power supply 1001 is configured to supply suitably regulated voltages to the electronic control circuitry within the lighting unit 101, including the micro-controller 1003, electrically erasable programmable read only memory (EEPROM) 1004, and driver circuitry 1005.

The thyristor circuit 1002 is configured to control a voltage supply to a lamp transformer 1006 in response to a signal received from the micro-controller 1003. Thus, a voltage between zero and mains voltage is supplied to lamp transformer 1006. The lamp transformer 1006 is configured such that, when it receives mains voltage, it supplies a voltage of twelve volts to the lamp 121, ie it supplies a voltage within the lamp's rating.

The micro-controller 1003 is an eight-bit RISC-like micro-controller designed for multiple input/output applications. A suitable micro-controller 1003 is sold by Holtek under the part number HT48C50A-1. The micro-controller 1003 has one hundred and sixty kilo-bytes of in-built random access memory (RAM). It also has programmable read only memory (PROM) containing the process instructions for the operation of the lighting control unit 101.

The micro-controller receives signals from the optical sensors 714 and 764, providing the micro-controller 1003 with data regarding the rotational movement of the motors 710 and 760 respectively, and signals from the optical sensors 716 and 766 which indicate to the micro-controller when the drive shafts 703 and 753 are in their home positions. The micro-controller also receives signals from the infrared sensor 706 and the light sensor 707. The light sensor in the present embodiment is a photodiode supplied by Vishay under part number BPW34, and a suitable infrared sensor is sold by JRC under part number NJL61V380.

The micro-controller is also able to supply signals to, and receive signals from, the EEPROM 1004. Thus, positional data and dimmer setting information may be stored on the EEPROM, and then retrieved, even after a discontinuity in the power supply. For example, during use the present dimmer setting of a lighting unit is stored in the EEPROM, so that when said lighting unit is first switched on, the last used dimmer setting can be looked up and relevant signals applied to the dimming thyristor circuit 1002.

The micro-controller 1003 is also configured to output signals to driver circuitry 1005. The driver circuitry 1005 comprises of power transistors for supplying voltages to the motors 710 and 760 in response to the signals received from the micro-controller.

### FIG. 11

A flowchart outlining the operation of the micro-controller of the lighting unit 101 is shown in FIG. 11. After receiving power at step 1101, the micro-controller 1003 retrieves the last used dimmer setting from the EEPROM 1004 and supplies corresponding signals to the thyristor circuitry 1002 at step 1102, thus causing the thyristor circuitry to supply the required power to the lamp 121. Thus, when the lighting unit first receives power, the lamp of the lighting unit is switched on with the dimming setting which was used just before the lighting unit was switched off. At step 1103, a question is asked as to whether a correctly modulated signal, ie a one kHz modulated signal, has been received from the photodiode 707. If this question is answered yes, the micro-controller responds to subsequent control signals received from infrared detector 706 at step 1104, before entering step 1105. Otherwise, if the question at step 1103 is answered no, then step 1105 is entered directly.

At step 1105, a question is asked as to whether a “select-all” code has been received from the infrared detector 706. If this question is answered no, the process re-enters step 1102 directly. If this question is answered yes, then the process enters step 1106 before reentering step 1102. At step 1106, the micro-controller 1003 responds to “position-select” control signals received from the infrared detector 706. These signals cause the micro controller to retrieve position data and dimmer setting data stored in EEPROM 1004 and control the lamp's position and power setting in a corresponding manner.

Thus, the micro-controller can be activated by the photodiode, to respond to infrared control codes on an individual basis at step 1103, or activated by the infrared detector to respond, as part of a group, with micro-controllers of other lighting units at step 1105.

### FIG. 12

The step 1104 of responding to control signals received from the infrared detector is shown in further detail in FIG. 12.

The micro-controller 1003 is configured to respond to control signals, received via the infrared detector, after modulated light has been received at the photodiode at step 1103. However, if control signals are not received for a pre-defined period of time, then the micro-controller is configured such that it will not respond to control signals again, until it has been re-activated at step 1103. Therefore, in order to monitor how recent control signals have been received, at step 1201 a timer is started.

A question is then asked at step 1202 as to whether a movement control signal has been received. If a movement control signal has been received, the process enters step 1203 in which drive signals are transmitted to the relevant motor until a movement control signal is no longer received from the infrared detector. When the movement control signals are no; longer being received, the drive signals are stopped. In addition, the timer started at step 1201 is re-started before step 1204 is entered.

If it is determined at step 1202 that a movement control signal has not been received then the process enters step 1204 directly. At step 1204 a question is asked as to whether a control signal relating to dim up, or dim down, or on, or off has been received. If such a signal has been received, corresponding signals are transmitted to the dimming thyristor circuit 1002 at step 1205, and the timer restarted before step 1206 is entered. Otherwise, step 1206 is entered directly from step 1204.

At step 1206 it is determined whether a control signal has been received from the infrared sensor, commanding that data defining the current position should be stored. If there has not, then step 1210 is entered directly, but if there has, then step 1207 is entered.

At step 1207 it is determined whether the current orientation of the lamp is known. The position of the lamp is only known if the lamp has been put in the home position since power-on, at step 1101. This is because the position of the lamp is calculated from movement data received from optical sensors 714 and 764 since the last time the lamp was in the home position. If the lamp's current position is known, then step 1209 is entered directly, but if it is not known, then the process first enters step 1208 before entering step 1209.

At step 1208, under the control of the micro-processor, signals are supplied to the motors until the home position is reached. By monitoring the data from sensors 714 and 716 during this movement, data defining the “current positon” is found. After determining the “current position” data, the lamp is moved back to the “current position”.

At step 1209 positional data of the lamp's current position is stored, along with data defining the lamp's present dimmer setting.

At step 1210 a question is asked as to whether a “position-select” control signal has been received from the infrared detector. If such a signal has been received, then the micro-controller responds to the received “position-select” control signal at step 1211, before entering step 1212. Otherwise, the process enters step 1212 directly from step 1210. The step 1211 is similar to step 1106, and will be described in detail with respect to

### FIG. 13.

At step 1212 a question is asked as to whether the timer has reached a pre-defined time. If the timer has reached the pre-defined time, this indicates that the operator 105 has not used the remote control unit 103 to adjust the lamp's settings within the pre-defined period, and step 1104 is exited. However, if the pre-defined time has not been reached by the timer then the process enters step 1213. At step 1213 a further question is asked to determine whether a “de-activate” control signal has been received indicating that the operator no longer requires the micro-controller to respond to control signals. If this is answered yes then the process exits step 1104, otherwise step 1202 is re-entered.

### FIG. 13

The step 1106 of responding to “position-select” control signals is shown in detail in FIG. 13. Firstly within step 1106, at step 1301, the micro-processor receives “position-select” control signals from the infrared receiver which identify the memory location containing the required positional data and dimmer setting data. At step 1302 the stored positional data and dimmer setting data is retrieved from the memory location identified at step 1301. At step 1303, a question is asked as to whether the current position of the lamp is known. If this question is answered yes then step 1305 is entered directly, otherwise the process first enters step 1304. At step 1304, under the control of the micro-controller, drive signals are transmitted to the motors to move the lamp to the “home” position. The current position is then known since it is the “home” position. At step 1305, a calculation is made to determine the required movement to move the lamp from the current position to the required position, defined by the data retrieved at step 1302. At step 1306, under the control of the micro-controller, drive signals are transmitted to the motors to move the lamp to the required position.

In response to dimmer setting data retrieved at step 1302, the micro-controller transmits signals to the thyristor circuitry 1002 causing said circuitry to supply the required power to the lamp, thereby producing the required dimmer setting. Upon completion of step 1306, step 1106 is completed and the process re-enters step 1102.

### FIG. 14

It should be understood, that light is used to select a lamp because its visibility allows the narrow light beam to be accurately directed towards the photodiode of the lighting units. However, once a lighting unit has been selected, it is then desirable for the radiation carrying the control signals to comprise of a wide beam so that operator accuracy is not necessary. In the main embodiment the wide beam of radiation was an infrared beam. However, in an alternative embodiment radio waves are used in place of infrared.

The main components of an alternative remote control unit to that of FIG. 4 are shown schematically in FIG. 14. The remote control unit of FIG. 14 is substantially the same as that of FIG. 4, except that the infrared LED 404 is replaced by a radio frequency generator 1401, a modulator circuit 1402 and an aerial 1403. The modulator circuit 1402 is configured to modulate a radio frequency signal received from radio frequency generator 1401 using control signals received from the micro-controller 401, and thus generate a modulated radio frequency signal. The radio frequency signal is then transmitted to lighting units via the aerial 1403.

### FIG. 15

The main electrical and electronic elements of an alternative lighting unit, suitable for receiving commands from the remote control unit of FIG. 14, are shown schematically in FIG. 15. The lighting unit of FIG. 15 is substantially the same as lighting unit 101, of FIG. 10, except that the infrared receiver 706 is replaced by an aerial 1501 and a receiver circuit 1502. Thus, the components of the lighting unit of FIG. 15, which are the same as those of FIG. 10 have been given the same numerical label.

The receiver circuit 1502 receives a modulated radio frequency signal from the aerial 1501, and from this signal it retrieves the modulating signal, i.e. the control signal. The modulating signal is then transmitted to the micro-controller 1003, where it is decoded.

Other operations of the remote control unit of FIG. 14 and the lighting unit of FIG. 15 are the same as the remote control unit 103 and lighting unit 101 respectively.

In a further alternative embodiment of the present invention, the lighting unit has a second individually moveable lamp and a corresponding second photodiode, connected to the micro-controller, for receiving the one kHz modulated light. The lighting unit enters its activated mode on receipt of the modulated light to either of its two photodiodes, but only the lamp corresponding to the receiving photodiode becomes selected. Thus, when activated, the lighting unit receives control signals from its infrared detector, and responds by moving, dimming etc. the lamp whose corresponding photodiode received the modulated light.

Therefore, like the lighting unit of the main embodiment, it is configured such that any of its independently moveable lamps may be selected by receipt of modulated light to a light sensor, and then orientated on receipt of control signals received in the form of coded infrared. This simplicity of operation is facilitated by the provision of a corresponding light sensor for each of the individually moveable lamps.

In a further alternative lighting system, said system also includes an alternative remote control device in additional to a remote control unit such as unit 201 or the remote control unit of FIG. 14. The alternative remote control device is configured to transmit the “select-all” and “position-select” commands in the same manner as the remote control unit, ie by codes transmitted over a radio link or by infrared, as appropriate. However, the Device is also configured to be programmed to store a sequence of moves entered on its keypad, or received from a distant computer over a bus system. Once programmed, the alternative remote control device is configured to periodically transmit commands to the lighting units of the system, and thereby move the lighting units through the programmed sequence of movements, without any further human, or computer, input. The device may also be configured to transmit commands to the lighting units in response to commands it receives from a distant computer over a bus system.

It was mentioned at the beginning of the description that standard, eg. halogen PAR36, lamps may be used as the lamps 121, 122 in the lamp housings 111, 112 respectively. These may give white light in their unmodified form, or may alternatively provide coloured light, eg. red, green or blue, by the addition of filters placed adjacent the lamps. The filters will be movable and will be controlled from the microcontroller 1003 shown in FIG. 10 in response to coded input from the remote control unit.

An alternative way of providing different coloured light from the lighting units is to employ discrete lamps instead of discrete filters. Where space is at a premium as regards the lighting unit, such lamps may be smaller than the equivalent lamp used in isolation and will be differently coloured—eg., as just mentioned, red, green and blue. In place of standard-type lamps, light-emitting diodes (LEDs) may be employed. Whatever form of lamp is used, they will be controlled by the microcontroller, as with the case of the moveable filters.

1-15. (canceled)

16. A lighting unit comprising:
a number of individually moveable lamps;
motor means for adjusting the position of said lamps;
controlling means for transmitting drive signals to said motor means in dependence upon received control signals;
a number of detectors for receiving remote signals;
wherein said detectors respond to two distinct kinds of signals, a first kind of signal being a beam of modulated light which when substantially aimed at one of said lamp activates said lamp, and a second kind of signal for triggering the positioning of said lamps without necessarily having to aim at said lamp.

17. A lighting unit according to claim 16, wherein a particular second kind of signal triggers the collective positioning of a group of lamps to at least one pre-determined positions.

18. A lighting unit according to claim 16, wherein means operatively connected to the lighting unit store a set of data defining a movement sequence and a timer triggers positioning at predefined periods, whereby at least one lighting unit is commanded to move through a sequence of movements.

19. A lighting unit according to claim 16, further comprising means for changing the color of the light radiated by the lighting units.
